(19) United States
(12) Patent Application Publication
(10) Pub. No.: US 2003/0004747 A1
(43) Pub. Date: Jan. 2, 2003

(54) Delivery control system

(75) Inventor: Gavin Howard Burton, Cammeray (AU)

Correspondence Address: RATNERPRESTIA, P O BOX 980, VALLEY FORGE, PA, 19482-0980, US

(73) Assignee: Boral Construction Materials Limited

(21) Appl. No.: 10/167,314

(22) Filed: Jun. 10, 2002

Related U.S. Application Data
(60) Provisional application No. 60/324,081, filed on Sep. 21, 2001.

(30) Foreign Application Priority Data
Jun. 14, 2001 (AU) PR5678

(51) Int. Cl. G06F 17/60

(52) U.S. Cl. 705/1; 705/34; 705/30

(57) ABSTRACT

A system controls orders and deliveries of products such as pre-mixed concrete deliveries in urban areas. A data matrix concerning product particulars, orders and progress towards delivery is built and utilized to control, for example, a fleet of delivery vehicles where a co-ordinated delivery of batches at suitably timed intervals is required. Vehicle position reporting and delivery status is used together with information on travel times and updated customer orders and variation in orders. The information stored permits accurate and efficient customer billing and sub-contractor management and accountancy.

### FIELD OF THE INVENTION

The present invention relates to delivery control systems and is more particularly concerned with a business methodology involving the use of a matrix of the data concerning product identification and its movements and delivery in a manner which effectively interrelates with recipients for the goods.

In this specification the invention will be exemplified with reference to the particular and somewhat complex problem of a business system to deal efficiently with the process of pre-mix concrete delivery to building sites with appropriate recordal and control systems operating in real time or virtually in real time; the system preferably includes the coordination of batch formation to customer orders, delivery, monitoring, provision of information to customers in relation to the various batches and all the ancillary information relevant to contractual arrangements. However, the invention is not necessarily so limited and equally applies to analogous business delivery and control systems using the novel combination of principles described herein.

### BACKGROUND TO THE INVENTION

There already exists tracking systems for monitoring movement of vehicles such as taxis whereby the vehicle is fitted with a global positioning system (GPS) portable receiver for determining accurately the GPS coordinates of the vehicle at any point in time. The vehicle has a radio transmitter which can transmit regularly or continuously the vehicle's position to a receiving system which monitors and plots the vehicle. While the present invention makes use of such GPS systems, a combination of significant further functionality is required to fulfil a long-standing need for effective solutions for system controls and reporting, particularly to industries like the pre-mix concrete industry. The business process needs to be controlled in real time and preferably control of the invoicing process is important. A further aim is to eliminate the current highly labour-consuming manual processes concerned with the checking of deliveries and the details concerning the deliveries. For example, generally pre-mix concrete contracts specify that the customer is charged extra for on-site delays caused by the customer in the concrete truck discharging its contents and therefore record keeping and proof of activities is important to the billing process. This is in addition to proof of delivery of the specified quantity of concrete and any additional charges for the handling of excess concrete in a batch beyond that required by the customer and to be returned for recycling.

It will be appreciated that for major building projects the pre-mix concrete supply is a complex project involving a batching plant, a multiplicity of independent transport operators whose separate trucks have to be coordinated for site delivery in a well organised, timed stream and then there is the need to keep accurate records for billing purposes. For example, a builder may have an engineer's estimate for the volume of concrete required for a particular pour, but only on placement will the final quantity be determined. The builder must have accurate records because the builder will need to substantiate additional charges to the owner of the project as well as to substantiate correct payments to subcontractors, such as concrete pumping operators who will be entitled to payment linked to the time for pumping or volume of concrete pumped.

The management of a typical pre-mix concrete business will include the use of subcontract drivers who own their own equipment with often different trucks having different capacity. Furthermore, management must cope with a multiplicity of projects being handled in parallel with often different pre-mix concrete specifications for each project. The context is one of handling a product with very limited shelf life, e.g. one and a half hours, which has to be transported by road to a site and the product properly placed in position, sometimes under difficult working conditions, in the limited shelf life of the product.

### SUMMARY OF THE INVENTION

In summary, a preferred embodiment of the invention is aimed at providing increased efficiency in fulfilling the process of delivery of construction materials and the associated business record keeping and the solution involves the integration of the management of the supply process with the customer's utilisation. For example, additional costs are incurred by builders if deliveries arrive late and pre-mix concrete companies experience losses when their delivery trucks and plant are not utilised to their full capacity, which will inevitably occur when customers do not unload trucks within the allocated timeslots and schedules are thrown into disarray. During a typical day, a pre-mix concrete company will need to manage a large number of delivery trucks distributed to service a large number of construction projects with the ability to adjust the batch formation and dispatch to suit the progress of the concrete pours at different jobs.

Due to the difficult working environment, particularly on large commercial building projects, pre-mix concrete truck drivers often experience difficulty in obtaining a proper customer signature for delivery and any waiting time, possibly because a responsible supervisor is engaged elsewhere on the site and not available to sign-off on the batch. Even when there is sign-off and a copy of the delivery docket is left at the site, it can easily become lost or damaged. Reconciliation for accounting purposes later becomes a very flawed process with many requests for extra copies of dockets in order for customers to reconcile their bills. This whole process leads to many small disputes which are, as a minimum, expensive in labour time to resolve.

In one aspect the present invention broadly consists in a method of operating a delivery system having:

(i) delivery vehicles arranged to receive GPS positioning information and transmitting, via a wireless link, data relating:

(a) to the vehicle position; and

(b) to the delivery transactions in relation to real time;

(ii) operating a computer data processing system:

(a) to receive and process the data from the delivery vehicles;

(b) to receive and process customer order information against which the delivery activity is correlated,

(c) the system being adapted to control a multiplicity of vehicles and

(d) to control a multiplicity of customer orders

(e) to control variations on customer orders

(f) to schedule further deliveries of the delivery vehicle to further customers based on updated information and

(g) to supply for customer information purposes details required by the customers to update on deliveries and to provide reports for accountancy and record keeping purposes.

In another aspect, the present invention may be defined as consisting in a system adapted to operate with a multiplicity of delivery vehicles each having GPS tracking facilities and means for producing a wireless signal containing data relating to vehicle positions, times and deliveries of product, the system having a computerised system for receiving customer orders and scheduling deliveries, processing the data from the vehicles against deliveries, means for receiving revised customer requirements, means for producing revised delivery scheduling and means for providing a customer accessible data file regularly updated to provide customer information on orders and deliveries and a data file for reporting and customer billing purposes.

In a third aspect, the invention may be defined in a computer software package adapted to operate on a digital computer and to give effect to the method described above or to operate a system to control product deliveries.

As applied to a pre-mix concrete delivery business, embodiments of the invention may include a polling system for polling each delivery vehicle to determine the position of the vehicle from time to time and then to calculate a revised arrival time for the vehicle at a customer site or a supply site such as a concrete batching plant. Preferably, the system records arrival at a site by reference to broadcast GPS coordinates of the site together with a sensor monitoring that the vehicle is stationery. Furthermore, with advantage the system sensors detect when discharge is commenced for the concrete by virtue of counter rotation of the mixer barrel. When discharge is complete, this is also detected and by these means an accurate record of delivery times and waiting times is computed so that correct accounting ensues.

A dynamic scheduler program may be used so that where a series of truckloads of concrete are required at a particular site, the batching time and dispatch time of subsequent trucks may be adjusted according to any traffic delays or site delays so that customers are supplied on site in an efficient manner within the shelf life of the product. By monitoring delivery, an electronic proof of delivery system can be included and provided to the customer, thereby providing a system which does not depend upon manual signature and annotation of delivery dockets and their correct return and filing both at the concrete company and the customer offices.

Preferably, use of the invention includes the provision of a customer portal so that not only can orders be received and updated, but also customers can have, in real time, up to date details of the order, the job status, the deliveries achieved and scheduled and finally reports which interface into an accounting system. By the use of appropriate technology, customers have the ability to access through a portable device the details of the job through a portal.

Ideally, the present invention leads to embodiments which permit a paperless system to be operated. Thus, a customer order will be received typically for a series of spaced deliveries to total a projected volume of concrete for a particular day. An electronic docket is generated by the system and, having regard to estimated travel times, a schedule is created for batch preparation and sequential truck filling and dispatch times. Each truck batch is recorded, the driver being provided electronically with delivery information. Updating through the data radio link occurs so that the system logs when the truck arrives at the delivery site, when delivery is commenced and when it finishes, and the system can then re-estimate the return time for the truck at the depot and schedule its next delivery run either to the same site or another job entirely.

Since each batch has a timed report associated with the volume of concrete delivered, the system can drive an accountancy system and customer reporting system. Furthermore, in the preferred system, a portal through a browsing system permits the customer to monitor in real time what is happening and subsequently to reconcile the bills received. Accordingly, queries concerning delivery details and the considerable cost of maintaining a filing system and extracting required duplicates from time to time with order dockets can be eliminated. Thus, significant savings for both the concrete company and the customer are possible. Furthermore, due to real time activity it is possible to achieve high customer satisfaction by adjusting the delivery schedules to optimise the supply to customers and maximise the servicing of a multiplicity of jobs on a particular day from a batching plant.

It will be appreciated that embodiments of the invention therefore offer an enhanced process offering substantial savings as well as providing convenience compared with an existing system. This contrasts with the present system which may be summarised as follows.

(a) A customer places an advance order specifying dates, requested times and volumes of concrete required including the concrete specification to be applied to the order. Larger jobs requiring more than one truck load will require the customer to specify the time interval between deliveries to allow for discharge.

(b) The customer's order is subject to an agreed pricing for volume inclusive of delivery, but waiting time is also charged if any truck is held on site for more than an agreed specified time. Therefore detailed and accurate record keeping is required to satisfy auditing and billing requirements.

(c) Each concrete batching plant requires a schedule in advance for each day's activities. The schedule requires estimation of the time taken for a truck to be loaded, to drive to a site, to discharge its load and return to the plant. The number of loads required must be established and the system loaded with the information of how many deliveries, ie cycles are required for a given job on a given day. This determines the number of trucks required for this job and since generally a multiplicity of jobs will be serviced from a single plant on a given day, efficiency requires integration of truck availability between the various jobs and the customer requirements.

In practice, schedules can easily be substantially disrupted, such as due to traffic congestion or technical problems at a given site, eg pumping problems or access problems requiring a longer than expected discharge time.

A multi-part set paper docket is traditionally generated and multiple parts provided to the driver who should leave one copy duly completed and signed off with the customer and obtain the signature of customer receipt on another copy which should be returned for filing and processing and billing purposes. In practice these dockets frequently become lost or damaged.

For illustrative purposes, an embodiment of the invention will now be described with reference to the accompanying drawings of which:

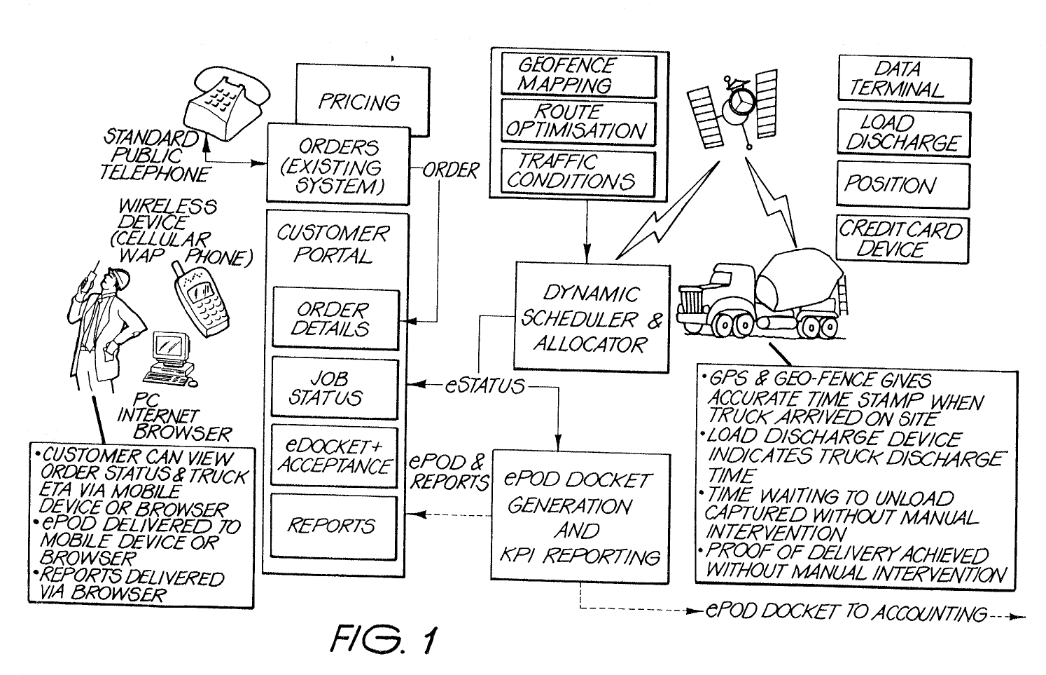

FIG. 1 is a schematic diagram of a system embodying the invention;

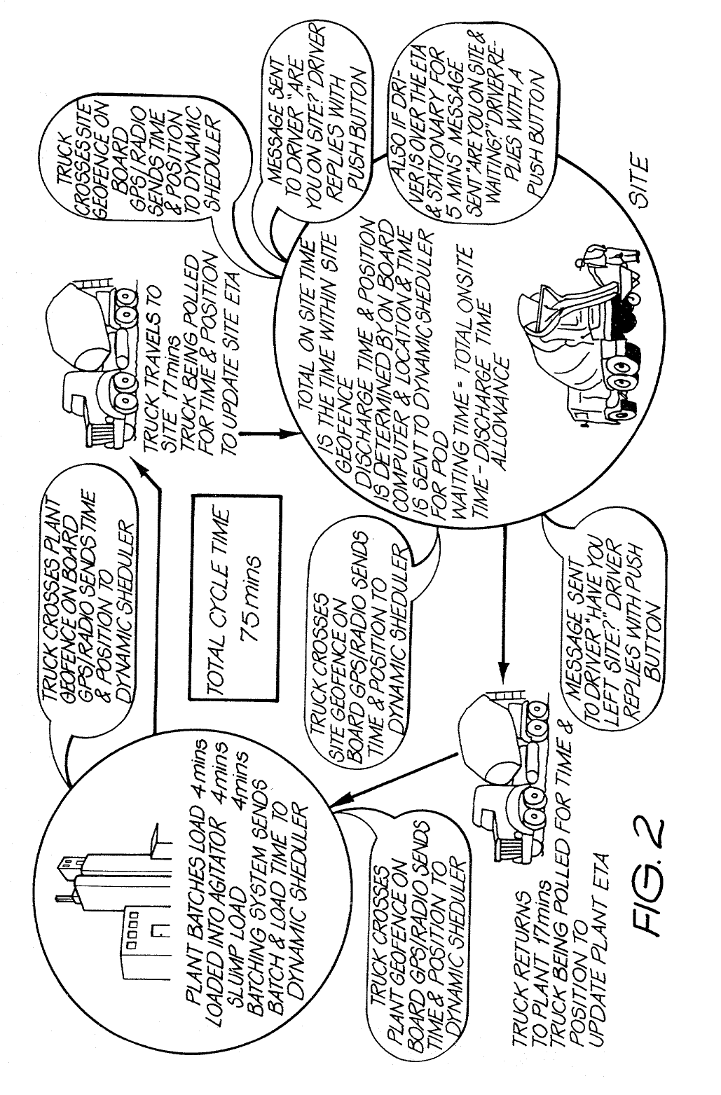

FIG. 2 is a diagram illustrating useful message systems to be used in controlling the delivery process with the present invention; and

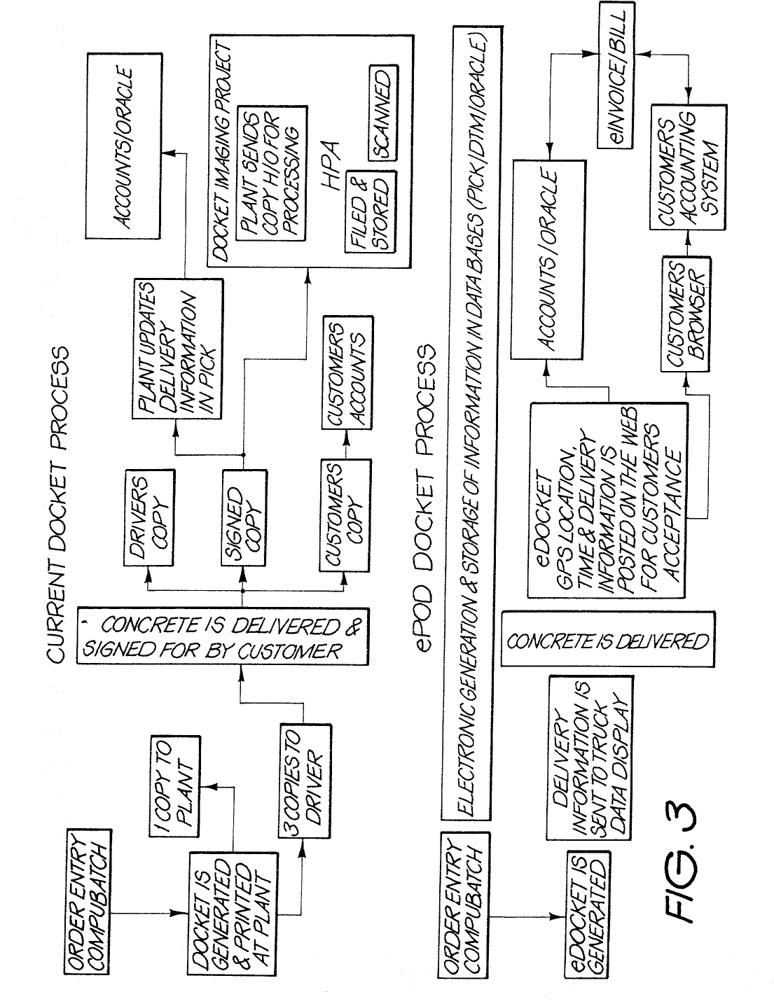

FIG. 3 compares a traditional paper docketing system with an electronic proof of delivery system integrated into preferred embodiments of the invention.

Referring first to FIG. 1, the schematic system diagram shows that the heart of the system is a dynamic scheduler and allocator which is drive by a database to provide geofence mapping, route optimisation and traffic conditions, these inputs being adapted to provide rapid updating of the system. Using a wireless link a series of concrete trucks provide data to the scheduler which includes up to date information on location of the truck, reporting when it arrives at a site and when its discharge is completed and thus providing proof of delivery, position coordinates being determined by GPS techniques with wireless reporting back to the dynamic scheduler.

The scheduler provides electronic status report output which is arranged to drive an electronic point of delivery docket and key performance indicator reporting. This links into an accounting system and further it generates output reports for customer convenience. The customer interface can be through conventional telephones, cellular telephones or Internet browser technology whereby the customer can confirm and even vary orders as well as see the progress of the job in question.

Referring now to the scheme of FIG. 2, an example is given of a concrete pre-mix business with a typical cycle for one truck being 75 minutes. The system can thus be set up to predict the time for any part of the cycle and monitoring and updating of progress permits the entire business to be regulated in real time. As shown in the top left corner of the diagram, the cycle begins with a truck crossing a “geofence” at the batching plant and an onboard GPS/radio system sends data on position and time to the dynamic scheduler as shown in FIG. 1. In this example 12 minutes are occupied in loading the truck and getting in ready for dispatch. On dispatch the truck GPS/radio system sends time and position data and travels along a predetermined route to a site. In the example, a 17 minute journey time has been estimated and the system is adapted to poll the truck periodically for time and position updating so that all concerned can know of any variation in predicted arrival time of the truck at the building site. Upon arrival of the truck at the building site again the GPS/radio system of the truck automatically sends the relevant signal to the scheduler. Preferably driver pushbuttons are provided to respond to standard message such as confirmation of whether the driver is on site and whether the driver is waiting. The truck is preferably fitted with automatic means for determining when discharge commences and stops and this sends appropriate messages to the scheduler so that the time on site is compared with the discharge charge allowance and any surcharge time can be billed under the contract. On leaving the geofence i.e. the range of geographic coordinates for the building site again the GPS/radio system on the truck activates to provide messaging and the cycle is completed by the truck arriving back at the batching plant.

The diagram of FIG. 3 demonstrates how the present system can provide efficient docketing for customer information, system management and accounting.

1. A method of operating a delivery system having:
(i) a delivery vehicle receive GPS positioning information and transmitting via a wireless link data relating:
(a) to the vehicle position; and
(b) to the delivery transactions in relation to real time;
(ii) operating a computer data processing system:
(a) to receive and process the data from the delivery vehicles;
(b) to receive and process customer order information against which the delivery activity is correlated,
(c) the system being adapted to control a multiplicity of vehicles and
(d) to control a multiplicity of customer orders
(e) to control variations on customer orders
(f) to schedule further deliveries of the delivery vehicle to further customers based on updated information and
(g) to supply for customer information purposes details required by the customers to update on deliveries and to provide reports for accountancy and record keeping purposes.

2. A system adapted to operate with a multiplicity of delivery vehicles each having GPS tracking facilities and means for producing a wireless signal containing data relating to vehicle positions, times and deliveries of product, the system having a computerised system for receiving customer orders and scheduling deliveries, processing the data from the vehicles against deliveries, means for receiving revised customer requirements, means for producing revised delivery scheduling and means for providing a customer accessible data file regularly updated to provide customer information on orders and deliveries and a data file for reporting and customer billing purposes.

3. A computer software package adapted to operate on a digital computer and to give effect to the method claimed in claim 1.

4. A method of managing a business of delivery of construction materials in a geographical zone, the method including:
(a) acquiring by wireless link from a fleet of delivery vehicles respective updated data packages indicative of vehicle position derived from a GPS position and status of deliveries,
(b) processing customer orders and amendments to orders,
(c) providing directions to the members of the fleet for further deliveries and times for dispatch,
(d) providing data substantially in real time for management and customers concerning progress of deliveries, and
(e) providing information for accountancy and plant administration purposes.

5. A method of managing pre-mixed concrete deliveries in accordance with claim 4, and including recording from the data packages information on vehicle transmit time to a delivery site, waiting time and discharge time; calculating customer billing in correlation with delivered quantities and contract adjustments dependent on recorded times and calculating remuneration entitlements to delivery driver based on recorded times and delivery amounts.

6. A method as claimed in claim 5, and including a system for polling each vehicle periodically to acquire the current data package.
